(19) United States
(12) Patent Application Publication
(10) Pub. No.: US 2013/0061150 A1
(43) Pub. Date: Mar. 7, 2013

(54) SYSTEM AND METHOD FOR MANAGING DYNAMIC STOREFRONTS

(71) Applicants: Michael A. Avina, Tampa, FL (US); Timothy M. Roberts, Tampa, FL (US)

(72) Inventors: Michael A. Avina, Tampa, FL (US); Timothy M. Roberts, Tampa, FL (US)

(73) Assignee: SAVTIRA CORPORATION, Tampa, FL (US)

(21) Appl. No.: 13/404,798

(22) Filed: Feb. 24, 2012

Related U.S. Application Data
(60) Provisional application No. 61/446,205, filed on Feb. 24, 2011.

(51) Int. Cl. G06F 3/048

(52) U.S. Cl. 715/744

(57) ABSTRACT

The disclosed embodiments relate to a method, an apparatus, and computer-readable medium storing computer-readable instructions for managing a storefront.

### RELATED APPLICATION DATA

This application claims priority to U.S. Provisional Application No. 61/446,205, filed Feb. 24, 2011, which is hereby incorporated by reference in its entirety.

### SUMMARY

The disclosed embodiment relates to a store management system that preferably comprises a distribution partner control panel providing management for content, advertisements, user/account registration, newsletter builder, style management, brand guidelines management, and currency controls, a communities control panel where an administrator can create/remove forums, ban users, and setup mailing lists, an affiliate marketing control panel where marketers can design programs, create mailing lists, segment customers, and design targeted marketing campaigns, a publisher control panel allowing publishers to manage the publication of content, and an analytics system that provides a detailed view of sales, visitor statistics, financial data marketing results, and trends. The currency rates can be blended by averaging the latest buy/sell data between several currencies. Publishers can send any kind of content to the publication system and specify what regions it can be sold in, preferred currency pricing, preferred markets for advertising, and how the content can be distributed. Affiliate marketers can develop targeted marketing campaigns and pricing/subscription schemes. Pricing can be multi currency and campaigns can be run across several regions simultaneously.

The disclosed embodiment further relates to a method for managing a storefront. An exemplary method comprises providing management for content, advertisements, user/account registration, newsletter builder, style management, brand guidelines management, and currency controls, providing a communities control panel where an administrator can create/remove forums, ban users, and setup mailing lists, providing an affiliate marketing control panel where marketers can design programs, create mailing lists, segment customers, and design targeted marketing campaigns, providing a publisher control panel allowing publishers to manage the publication of content, and providing an analytics system that provides a detailed view of sales, visitor statistics, financial data marketing results, and trends.

In addition, the disclosed embodiment relates to an apparatus for managing a storefront. An exemplary apparatus comprises one or more processors, and one or more memories operatively coupled to at least one of the one or more processors and containing instructions that, when executed by at least one of the one or more processors, cause at least one of the one or more processors to provide management for content, advertisements, user/account registration, newsletter builder, style management, brand guidelines management, and currency controls, provide a communities control panel where an administrator can create/remove forums, ban users, and setup mailing lists, provide an affiliate marketing control panel where marketers can design programs, create mailing lists, segment customers, and design targeted marketing campaigns, provide a publisher control panel allowing publishers to manage the publication of content, and provide an analytics system that provides a detailed view of sales, visitor statistics, financial data marketing results, and trends.

Moreover, the disclosed embodiment relates to at least one non-transitory computer-readable medium storing computer-readable instructions that, when executed by one or more computing devices, manage a storefront. Exemplary instructions cause at least one of the one or more computing devices to provide management for content, advertisements, user/account registration, newsletter builder, style management, brand guidelines management, and currency controls, provide a communities control panel where an administrator can create/remove forums, ban users, and setup mailing lists, provide an affiliate marketing control panel where marketers can design programs, create mailing lists, segment customers, and design targeted marketing campaigns, provide a publisher control panel allowing publishers to manage the publication of content, and provide an analytics system that provides a detailed view of sales, visitor statistics, financial data marketing results, and trends.

### BRIEF DESCRIPTION OF THE DRAWINGS

FIG. 1 illustrates an exemplary embodiment.

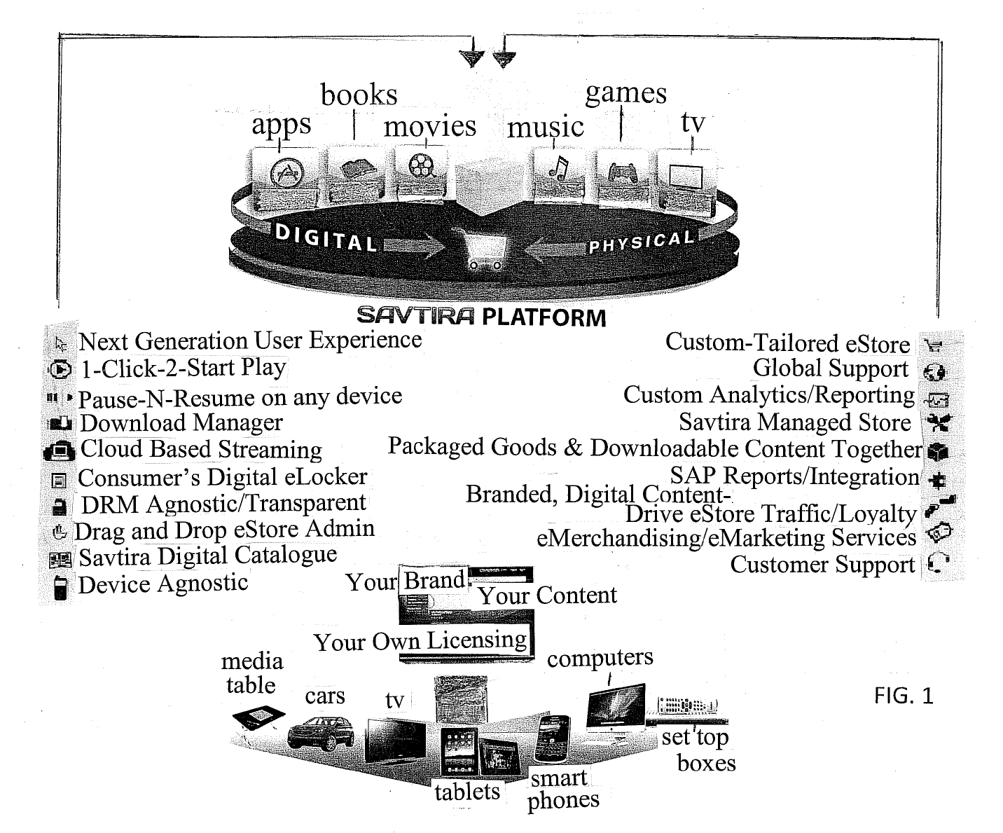

FIG. 2 illustrates an exemplary embodiment.

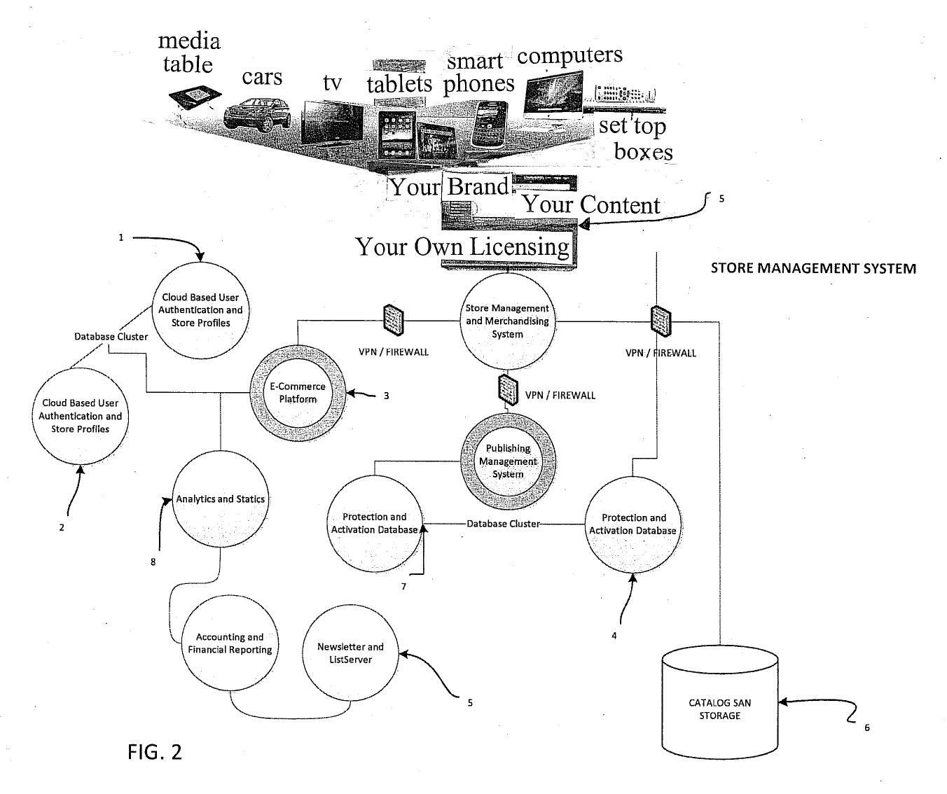

FIG. 3 illustrates an exemplary computing device according to the disclosed embodiment.

### DETAILED DESCRIPTION

The Store Management System for our distribution Partners allows them to login to a Web 4.0 GUI front end and select the content they would like to sell on their stores. The system has features for ON/OFF selections which they can choose to automate the process for adding content, customizing, controlling marketing and merchandising (product placement) and advertising and to setup their general store policies. The system allows for technical features for direct download and server side streaming content/media from the cloud which allows them to sell in direct sale, rental or purchase.

Distribution Partner Logs in to the Store Management Portal over the Internet. They select the General Profile options for the store:
a. They setup their general store profile and provide their payment information
b. Select Parental Controls and Ratings Levels/ESRB Ratings
c. Select Media Types they want to sell, i.e.; physical goods, music, movies, video games, business application, OTT/IPTV, Internet Radio, EBooks and Audio Books.
d. Select the Content/Media Genres they wish to have on their stores.
e. Setup Countries they want to sell in.
f. Select whether they want to convert the user registration to a School Compliance for kids and teen user registration.
g. They setup their custom colors of the stores and private branding which is also fed into the download manager if they elected to offer this

They can control their AD Space on their stores and setup ads for their stores. They can Feature videos on the main page and sub-genre main pages. They can control the merchandising of their stores. They can use our automated newsletter builder. They can manage their communities, forums and user databases. They can manage their user registrations and provide account activations. They can manage the content on the stores through a CSS management tool built into the Store Management System. They can do automated mailings to their opt-in users who are in our integrated listserver. They can elect to setup Automated Payments. The system uses a schema which allows for a blended currency exchange rate and also allows the publisher or content owner to view these reports in any currency or language.

They can view reports for:
a. Dashboard data on all transactions
b. Full Analytics and Statistics
c. Financial Data

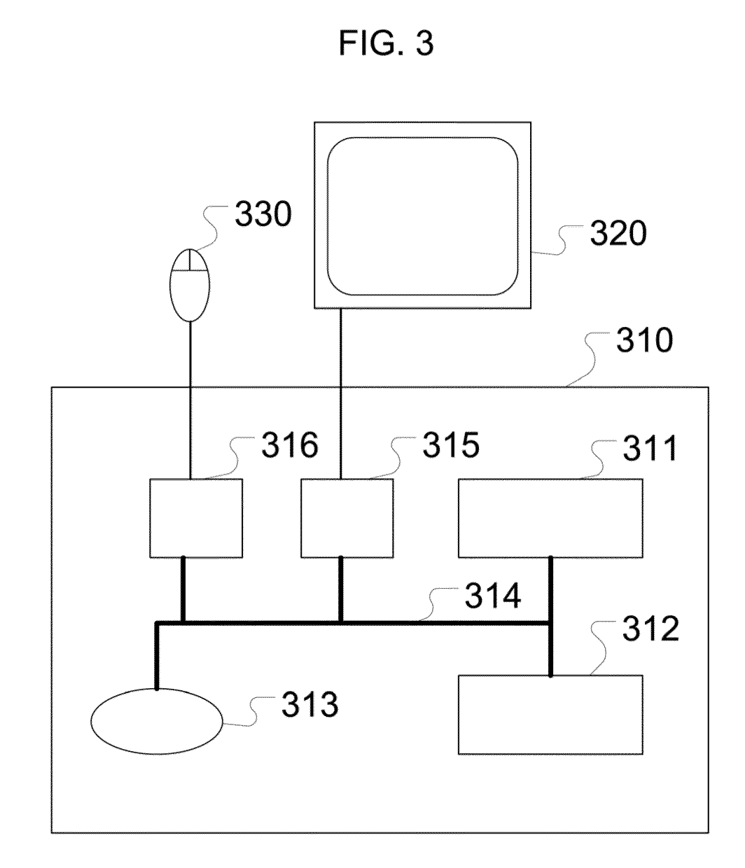

The embodiments described herein may be implemented with any suitable hardware and/or software configuration, including, for example, modules executed on computing devices such as computing device 310 of FIG. 3. Embodiments may, for example, execute modules corresponding to steps shown in the methods described herein. Of course, a single step may be performed by more than one module, a single module may perform more than one step, or any other logical division of steps of the methods described herein may be used to implement the processes as software executed on a computing device.

Computing device 310 has one or more processing device 311 designed to process instructions, for example computer readable instructions (i.e., code) stored on a storage device 313. By processing instructions, processing device 311 may perform the steps set forth in the methods described herein. Storage device 313 may be any type of storage device (e.g., an optical storage device, a magnetic storage device, a solid state storage device, etc.), for example a non-transitory storage device. Alternatively, instructions may be stored in remote storage devices, for example storage devices accessed over a network or the internet. Computing device 310 additionally has memory 312, an input controller 316, and an output controller 315. A bus 314 operatively couples components of computing device 310, including processor 311, memory 312, storage device 313, input controller 316, output controller 315, and any other devices (e.g., network controllers, sound controllers, etc.). Output controller 315 may be operatively coupled (e.g., via a wired or wireless connection) to a display device 320 (e.g., a monitor, television, mobile device screen, touch-display, etc.) In such a fashion that output controller 315 can transform the display on display device 320 (e.g., in response to modules executed). Input controller 316 may be operatively coupled (e.g., via a wired or wireless connection) to input device 330 (e.g., mouse, keyboard, touch-pad, scroll-ball, touch-display, etc.) In such a fashion that input can be received from a user (e.g., a user may input with an input device 330 a dig ticket).

Of course, FIG. 3 illustrates computing device 310, display device 320, and input device 330 as separate devices for ease of identification only. Computing device 310, display device 320, and input device 330 may be separate devices (e.g., a personal computer connected by wires to a monitor and mouse), may be integrated in a single device (e.g., a mobile device with a touch-display, such as a smartphone or a tablet), or any combination of devices (e.g., a computing device operatively coupled to a touch-screen display device, a plurality of computing devices attached to a single display device and input device, etc.). Computing device 310 may be one or more servers, for example a farm of networked servers, a clustered server environment, or a cloud network of computing devices.

While systems and methods are described herein by way of example and embodiments, those skilled in the art recognize that disclosed systems and methods are not limited to the embodiments or drawings described. It should be understood that the drawings and description are not intended to be limiting to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

Various embodiments of the disclosed embodiment have been disclosed herein. However, various modifications can be made without departing from the scope of the embodiments as defined by the appended claims and legal equivalents.

What is claimed is:

1. A method for managing a storefront, the method comprising:
providing management for content, advertisements, user/account registration, newsletter builder, style management, brand guidelines management, and currency controls;
providing a communities control panel where an administrator can create/remove forums, ban users, and setup mailing lists;
providing an affiliate marketing control panel where marketers can design programs, create mailing lists, segment customers, and design targeted marketing campaigns;
providing a publisher control panel allowing publishers to manage the publication of content; and
providing an analytics system that provides e detailed view of sales, visitor statistics, financial data marketing results, and trends.

2. An apparatus for managing a storefront, the apparatus comprising:
one or more processors; and
one or more memories operatively coupled to at least one of the one or more processors and containing instructions that, when executed by at least one of the one or more processors, cause at least one of the one or more processors to:
provide management for content, advertisements, user/account registration, newsletter builder, style management, brand guidelines management, and currency controls;
provide a communities control panel where an administrator can create/remove forums, ban users, and setup mailing lists;
provide an affiliate marketing control panel where marketers can design programs, create mailing lists, segment customers, and design targeted marketing campaigns;
provide a publisher control panel allowing publishers to manage the publication of content; and
provide an analytics system that provides a detailed view of sales, visitor statistics, financial data marketing results, and trends.

9. At least one non-transitory computer-readable medium storing computer-readable instructions that, when executed by one or more computing devices, manage a storefront, the instructions causing at least one of the one or more computing devices to:
provide management for content, advertisements, user/account registration, newsletter builder, style management, brand guidelines management, and currency controls;
provide a communities control panel where an administrator can create/remove forums, ban users, and setup mailing lists;
provide an affiliate marketing control panel where marketers can design programs, create mailing lists, segment customers, and design targeted marketing campaigns;
provide a publisher control panel allowing publishers to manage the publication of content; and
provide an analytics system that provides a detailed view of sales, visitor statistics, financial data marketing results, and trends.
